(19) United States
(12) Patent Application Publication
(10) Pub. No.: US 2025/0217907 A1
(43) Pub. Date: Jul. 3, 2025

(54) METHOD AND APPARATUS FOR COLLECTING INGREDIENT INFORMATION FOR EACH DISH AT RESTAURANT AND PROVIDING INFORMATION ON NUTRIENTS CONSUMED BY DATE BASED ON RESTAURANT VISIT INFORMATION

(71) Applicant: Jeongtae KIM, Santa Clara, CA (US)

(72) Inventor: Jeongtae KIM, Santa Clara, CA (US)

(21) Appl. No.: 18/985,766

(22) Filed: Dec. 18, 2024

(30) Foreign Application Priority Data
Dec. 28, 2023 (KR) 10-2023-0193811

(51) Int. Cl. G06Q 50/12

(52) U.S. Cl. CPC G06Q 50/12

(57) ABSTRACT

The present invention relates to a method and apparatus for collecting ingredient information for each dish at a restaurant and providing information on nutrients consumed by date based on restaurant visit information, and more particularly, to a method and apparatus for verifying basic information for each dish at an individual restaurant collected from a first user based on feedback from a plurality of second users, confirmation from restaurant managers, etc., thereby collecting ingredient information for each dish at the individual restaurant and providing information on nutrients consumed by date based on restaurant visit information of a third user.

### CROSS-REFERENCE TO RELATED APPLICATION

This application claims priority to and the benefit of Korean Patent Application No. 10-2023-0193811, filed on Dec. 28, 2023, the disclosure of which is incorporated herein by reference in its entirety.

### BACKGROUND

### 1. Field of the Invention

The present invention relates to a method and apparatus for collecting ingredient information for each dish at a restaurant and providing information on nutrients consumed by date based on restaurant visit information, and more particularly, to a method and apparatus for verifying basic information for each dish at an individual restaurant collected from a first user based on feedback from a plurality of second users, confirmation from restaurant managers, etc., thereby collecting ingredient information for each dish at the individual restaurant and providing information on nutrients consumed by date based on restaurant visit information of a third user.

### 2. Discussion of Related Art

In modern urban life, many people are increasingly purchasing and eating meals at restaurants due to their busy schedules and pursuit of convenience. Such eating habits increase the dependence on food from restaurants, and most meals are in the form of standardized dishes provided at restaurants. In this process, consumers face a situation where it is difficult to obtain information about the exact ingredients or nutrients of the food they are eating.

Various nutritional management applications exist in the current market, but these apps mainly focus on nutritional information of general foods and have limitations in providing information about specific ingredients or nutrients of specific dishes actually consumed at restaurants by users. As a result, it is difficult for users to know the exact nutritional values of foods they are eating, and this may be an obstacle in maintaining healthy eating habits.

The health status of an individual is closely related to eating habits, and it is important to select a diet that fits specific health conditions or nutritional needs. In the current system, a function of recommending an appropriate dish at a restaurant according to an individual's health status or specific nutritional needs is insufficient, and this leaves a crucial gap in health management.

Based on this background, the present invention is directed to providing a method and apparatus that help a user identify the exact ingredients and nutritional information of dishes at a restaurant and easily select a diet suitable for his or her health status. To this end, the present invention provides a method and apparatus for verifying ingredient information through feedback on menu information collected from a plurality of users and confirmation from restaurant managers and providing personalized nutritional information based on meal records and health data of a user. This approach can make an important contribution to individuals' management of healthy eating habits.

### SUMMARY OF THE INVENTION

The present invention aims to achieve the following objectives to address the problems described above.

The present invention is directed to providing a method and apparatus for collecting ingredient information for each dish at a restaurant and providing information on nutrients consumed by date based on restaurant visit information.

The present invention is also directed to providing a method and apparatus for verifying basic information for each dish at an individual restaurant collected from a first user based on feedback from a plurality of second users, confirmation from restaurant managers, etc., thereby collecting ingredient information for each dish at the individual restaurant and providing information on nutrients consumed by date based on restaurant visit information of a third user.

The present invention is also directed to providing a method and apparatus that help a user identify the exact ingredients and nutritional information of dishes at a restaurant and easily select a diet suitable for his or her health status.

The present invention is also directed to providing a method and apparatus for verifying ingredient information through feedback on menu information collected from a plurality of users and confirmation from restaurant managers and providing personalized nutritional information based on meal records and health data of a user.

The present invention is also directed to providing a method and apparatus capable of recommending a restaurant that provides a dish using ingredients recommended for a user based on health information and position information of the user.

The present invention is also directed to providing a method and apparatus for providing an opportunity to use reward points based on a service run by a server to pay for food in restaurants that collaborate to secure accurate information of ingredients for each dish and providing an influx of users of the service to the restaurants, thereby identifying the exact ingredients and nutritional information of dishes at restaurants.

The present invention is also directed to providing a method and apparatus for assigning different weighted values based on past history of each user for those providing basic restaurant menu information or those providing feedback information on accuracy of the basic restaurant menu information, thereby promoting efficiency of sorting out accurate information.

The present invention is also directed to providing a method and apparatus for, when a user is to visit a restaurant together with other users who are grouped with the user through a combination of nutritional management and a social network, generating information of restaurants that provide common dishes among dishes previously eaten by the users who are to visit the restaurant together and providing information of recommended restaurants and recommended dishes, and to each of the other users who are grouped with the user, providing information on nutrients consumed on the date on which he or she visited the restaurant together with the user.

The present invention is also directed to providing a method and apparatus allowing a user to, based on recipe information for each dish at restaurants collected from users, receive cooking simulation information relating to an appearance, a taste, a nutritional state, etc., of food as a result of cooking based on a unique recipe of a restaurant or a partially modified recipe through an artificial intelligence (AI)-based cooking simulation model, and allowing the user to order food based on the unique recipe of the restaurant or the partially modified recipe.

The present invention is also directed to providing a method and apparatus for, based on information of previously eaten dishes that is received from a user, proposing a modified recipe for a specific dish at a restaurant that the user is currently visiting for the taste and nutrition of the specific dish to be close to frequently consumed taste and nutrition based on cooking simulations of the previously eaten dishes and allowing the user to order food based on the proposed recipe.

The objectives of the present invention are not limited to those mentioned above, and other unmentioned objectives should be clearly understood by those of ordinary skill in the art based on the following description.

Various embodiments of the present invention provide an operation method of a server in a communication system. The server includes a transceiver, a memory, and a processor. The method includes a process of receiving basic restaurant menu information including restaurant information, dish information, and ingredient information from a first user terminal through the transceiver, a process of sending the basic restaurant menu information to a plurality of second user terminals through the transceiver, a process of receiving feedback information related to accuracy of the basic restaurant menu information from the plurality of second user terminals through the transceiver, a process of, based on the basic restaurant menu information and the feedback information, generating restaurant menu information including dish and ingredient information for each restaurant through the processor, a process of receiving restaurant visit information including information on a visited restaurant and an eaten dish by date from a third user terminal through the transceiver, a process of, based on the restaurant menu information and the restaurant visit information, generating or updating statistical information of nutritional components consumed by date for the third user terminal through the processor, and a process of sending the statistical information of the nutritional components consumed by date to the third user terminal through the transceiver.

Various embodiments of the present invention provide a server in a communication system. The server includes a transceiver, a memory, and a processor, and the processor is configured to perform an operation method of the server in the communication system according to various embodiments of the present invention.

Various embodiments of the present invention provide a computer program recorded in a computer readable recording medium. The computer program is configured to perform an operation method of a server in a communication system according to various embodiments of the present invention.

### BRIEF DESCRIPTION OF THE DRAWINGS

The above and other objects, features, and advantages of the present invention will become more apparent to those of ordinary skill in the art by describing exemplary embodiments thereof in detail with reference to the accompanying drawings, in which:

FIG. 1 illustrates a communication system according to various embodiments of the present invention;

FIG. 2 illustrates a block diagram of configurations of a user terminal and a restaurant terminal according to various embodiments of the present invention;

FIG. 3 illustrates a block diagram of a configuration of a server according to various embodiments of the present invention; and

FIG. 4 illustrates an operation process of the server according to various embodiments of the present invention.

### DETAILED DESCRIPTION OF EXEMPLARY EMBODIMENTS

Hereinafter, exemplary embodiments of the present invention will be described in detail with reference to the accompanying drawings to allow those of ordinary skill in the art to which the present invention pertains to easily practice the present invention. The present invention may be implemented in various different forms and is not limited to the embodiments described herein.

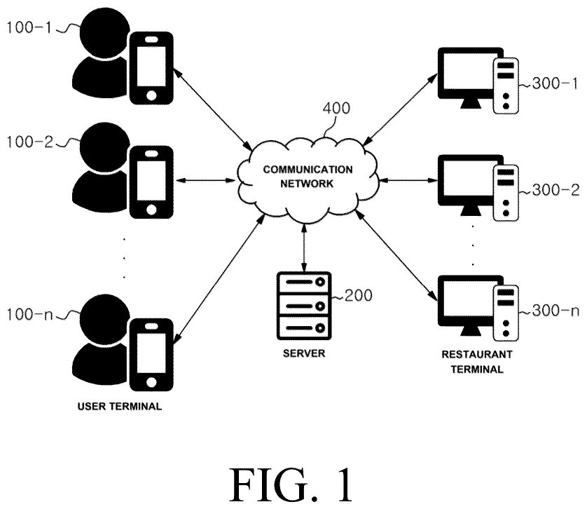

FIG. 1 illustrates a communication system according to various embodiments of the present invention.

Referring to FIG. 1, a communication system according to various embodiments of the present invention includes user terminals 100 (100-1, 100-2, 100-n), a server 200, restaurant terminals 300 (300-1, 300-2, . . . 300-n), and a wired/wireless communication network 400.

The user terminals 100 (100-1, 100-2, . . . 100-n) are terminals operated by users who visit restaurants and buy food. The user terminals 100 (100-1, 100-2, . . . 100-n) are electronic devices that can exchange information with the server 200 through the wired/wireless communication network 400. The user terminals 100 (100-1, 100-2, . . . 100-n) may be electronic devices such as a personal computer, a cellular phone, a smartphone, and a tablet computer including an input device through which information can be input, an output device through which information can be output, a memory that can store information, a transceiver that can transmit and receive information, at least one processor that can perform an arithmetic operation on information, and a camera. A first user terminal, a plurality of second user terminals, a third user terminal, a plurality of fourth user terminals, and a plurality of fifth user terminals according to various embodiments of the present invention correspond to the user terminals 100 (100-1, 100-2, . . . 100-n) of FIG. 1.

The server 200 is a server operated by a provider of a service collecting ingredient information for each restaurant menu and providing information on nutrients consumed by date based on restaurant visit information. The server 200 is an electronic device that can exchange information with the user terminals 100 (100-1, 100-2, . . . 100-n) and the restaurant terminals 300 (300-1, 300-2, . . . 300-n) through the wired/wireless communication network 400. The server 200 may be an electronic device including a memory that can store information, a transceiver that can transmit and receive information, and at least one processor that can perform an arithmetic operation on information.

The restaurant terminals 300 (300-1, 300-2, . . . 300-n) are terminals operated by restaurant managers. The restaurant terminals 300 (300-1, 300-2, . . . 300-n) are electronic devices that can exchange information with the server 200 through the wired/wireless communication network 400. The restaurant terminals 300 (300-1, 300-2, . . . 300-n) may be electronic devices such as a personal computer, a cellular phone, a smartphone, and a tablet computer including an input device through which information can be input, an output device through which information can be output, a memory that can store information, a transceiver that can transmit and receive information, and at least one processor that can perform an arithmetic operation on information.

The wired/wireless communication network 400 provides a communication path along which the user terminals 100 (100-1, 100-2, . . . 100-n), the server 200, and the restaurant terminals 300 (300-1, 300-2, . . . 300-n) can transmit and receive signals and data to and from one another. The wired/wireless communication network 400 is not limited to a communication method according to a specific communication protocol, and any appropriate communication method may be used according to implementation examples. For example, when configured as an Internet protocol (IP)-based system, the wired/wireless communication network 400 may be implemented as a wired/wireless Internet network, and when the user terminals 100 (100-1, 100-2, . . . 100-n), the server 200, and the restaurant terminals 300 (300-1, 300-2, . . . 300-n) are implemented as mobile communication terminals, the wired/wireless communication network 400 may be implemented as a wireless network such as a cellular network or a wireless local area network (WLAN).

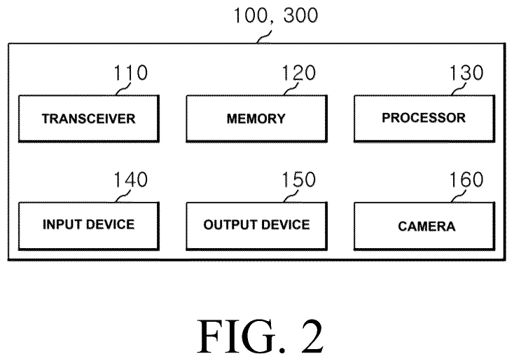

FIG. 2 illustrates a block diagram of configurations of a user terminal according to various embodiments of the present invention.

A first user terminal, a plurality of second user terminals, a third user terminal, a plurality of fourth user terminals, and a plurality of fifth user terminals according to various embodiments of the present invention correspond to the user terminals 100 (100-1, 100-2, . . . 100-n) of FIG. 2. According to various embodiments of the present invention, the first user terminal, the plurality of second user terminals, the third user terminal, the plurality of fourth user terminals, and the plurality of fifth user terminals may correspond to terminals identical to each other according to circumstances or may correspond to terminals different from each other according to circumstances.

Referring to FIG. 2, the user terminals 100 (100-1, 100-2, . . . 100-n) according to various embodiments of the present invention each include a transceiver 110, a memory 120, a processor 130, an input device 140, an output device 150, and a camera 160.

The transceiver 110 is connected to the processor 130 and sends and/or receives a signal. The entirety or a portion of the transceiver 110 may be referred to as a transmitter, a receiver, or a transceiver. The transceiver 110 may support a wired connection system and at least one of various wireless communication standards such as an Institute of Electrical and Electronics Engineers (IEEE) 802.xx system, an IEEE Wi-Fi system, a 3rd Generation Partnership Project (3GPP) system, a 3GPP Long Term Evolution (LTE) system, a 3GPP 5G new radio (NR) system, a 3GPP2 system, and Bluetooth, which are wireless connection systems. The transceiver 110 may support wireless connection systems ranging from 1G to 6G. The transceiver 110 may support operation of a computer system using a cloud computing technology.

The memory 120 may be connected to the transceiver 110, the processor 130, the input device 140, and the output device 150 and may store information input through the input device 140, information received from the server 200 through communication of the transceiver 110, etc. In addition, the memory 120 may be connected to the processor 130 and may store data such as a basic program for operation of the processor 130, an application program, settings information, and information generated by the processor 130 in an arithmetic operation. The memory 120 may be configured as a volatile memory, a non-volatile memory, or a combination of a volatile memory and a non-volatile memory. In addition, the memory 120 may provide stored data according to a request of the processor 130.

The processor 130 may be configured to implement procedures and/or methods proposed in the present invention. The processor 130 controls the overall operations of the user terminals 100 (100-1, 100-2, . . . 100-n) or the restaurant terminals 300 (300-1, 300-2, . . . 300-n). For example, the processor 130 sends or receives information, etc., through the transceiver 110. Also, the processor 130 records and reads data to the memory 120. Also, the processor 130 receives information through the input device 140. In addition, the processor 130 outputs information through the output device 150. The processor 130 may include at least one processor.

The input device 140 may be connected to the processor 130 and may input information, etc. According to one embodiment, the input device 140 may input information, etc., received from another device connected to the wired/wireless communication network 400 through the transceiver 110. The input device 140 may include a touch display, a keypad, a keyboard, etc.

The output device 150 may be connected to the processor 130 and may output information, etc., in the form of video or audio. According to one embodiment, the output device 150 may output information, etc., received from another device connected to the wired/wireless communication network 400 through the transceiver 110. The output device 150 may include a display, a speaker, etc.

The camera 160 may be connected to the processor 130 and may capture an image of an object in front of it.

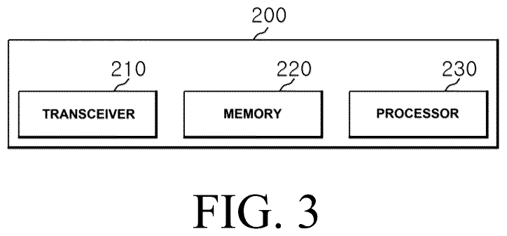

FIG. 3 illustrates a block diagram of a configuration of a server according to various embodiments of the present invention.

Referring to FIG. 3, the server 200 according to various embodiments of the present invention includes a transceiver 210, a memory 220, and a processor 230.

The transceiver 210 is connected to the processor 230 and sends and/or receives a signal. The entirety or a portion of the transceiver 210 may be referred to as a transmitter, a receiver, or a transceiver. The transceiver 210 may support a wired connection system and at least one of various wireless communication standards such as an IEEE 802.xx system, an IEEE Wi-Fi system, a 3GPP system, a 3GPP LTE system, a 3GPP 5G NR system, a 3GPP2 system, and Bluetooth. The transceiver 210 may support wireless connection systems ranging from 1G to 6G. The transceiver 210 may support operation of a computer system using a cloud computing technology.

The memory 220 may be connected to the transceiver 210 and may store information, etc., received from the user terminals 100 (100-1, 100-2, . . . 100-n) or the restaurant terminals 300 (300-1, 300-2, . . . 300-n) through communication of the transceiver 210. In addition, the memory 220 may be connected to the processor 230 and may store data such as a basic program for operation of the processor 230, an application program, settings information, and information generated by the processor 230 in an arithmetic operation. The memory 220 may be configured as a volatile memory, a non-volatile memory, or a combination of a volatile memory and a non-volatile memory. In addition, the memory 220 may provide stored data according to a request of the processor 230.

The processor 230 may be configured to implement procedures and/or methods proposed in the present invention. The processor 230 controls the overall operations of the server 200. For example, the processor 230 sends or receives information, etc., through the transceiver 210. Also, the processor 230 records and reads data to the memory 220. The processor 230 may include at least one processor.

The technical features of the present invention can be summarized as follows.

### 1. Related Technologies

(1) Object recognition using artificial intelligence (AI) cameras
(2) Character recognition
(3) Voice recognition
(4) Analysis of genetic vulnerabilities of individuals using genetic analysis technology
(5) Data collection and classification technologies such as File Transfer Protocol (FTP), Cookie, Tag, Bot, Web Crawling, parsing, and scraping
(6) Text mining technology
(7) AI technology utilizing analyzed data
(8) Recognition technology for automatically classifying and saving each piece of uploaded content

### 2. Data Collection Sources

(1) Information on ingredients and cooking methods provided by restaurants
(2) Photos of eaten food uploaded by participants.
(3) Data information described for dishes selected when ordering at restaurants
(4) Review data by restaurant
(5) Data open on the Internet (homepages, blogs, cafes, news, YouTube, etc.)
(6) Food nutritional component database (Public, Private)
(7) Personal health checkup information
(8) Questionnaire response data
(9) Information on food allergies
(10) Information on substances that have positive or negative effects on each part of the body
(11) Ingredients provided on labels of food for sale
(12) Genetic information provided by participants
(13) Information on intergenerational family health history
(14) Shopping receipts of individuals
(15) Label information from food manufacturers (prompt to record information in quick response (QR) codes)
(16) Regular participant reviews on nutritional information and health information-related reports
(17) Health functional foods
(18) Objectivity derived by comparing the collective knowledge of many participants with food information from existing official accounts

### 3. Analysis Items

(1) Ingredients used
(2) Information on sauces used
(3) Information on various additives
(4) Levels of various tastes (salty, sweet, sour, bitter, spicy, etc.; analysis through words used by participants who perform evaluation)
(5) Fermentation status
(6) Various information on ingredients purchased by restaurants such as place of purchase and purchase amount of each ingredient
(7) Changes in nutrients and calorie calculations according to cooking methods (boiling, grilling, steaming, fresh, etc.)
(8) Effects on nutrients according to how ingredients are stored
(9) Effects on health according to how ingredients are stored
(10) Changes in nutrients according to how ingredients are prepared

### 4. Utilization of Nutritional Information

(1) Analysis of correlation between characteristics and nutritional intake information of individuals through genetic analysis using AI
(2) Analysis of appropriateness of intake of each ingredient
(3) Analysis and provision of effects of consumed ingredients on health of individuals
(4) Pre-identifying and warning about ingredients and nutritional supplements containing specific substances that negatively affect health of individuals
(5) Recommendation of necessary exercise
(6) Recommendation (of food, nutritional supplements, exercise types, exercise amounts, etc.) according to changes in health status according to lifestyles
(7) Analysis and provision of possible effects on health of individuals by converting the number times specific ingredient is eaten into data by period
(8) Integrating eating (meal) information, etc., to provide statistical information on specific nutrients or ingredients by day, week, month, year, etc.
(9) Health statuses of individuals and nutritional information on food are integrated, and genetically weak constitutions of individuals and various information on health statuses in different lifestyles are compared using AI to suggest foods (ingredients, etc.) to avoid and foods to eat and to provide recommendations, warnings, etc., preemptively or at an appropriate time.
(10) Function of gathering food recall and risk information announced by each country's food-related agency and providing it to participants who consumed products of concern or ate in regions of concern
(11) Function of gathering and providing newly announced information on ingredients that may have positive or negative effects according to genetic or current health statuses of individuals
(12) Information on ingredients preferred by customers can be provided to restaurant owners, distributors, and producers.
(13) Information on popular ingredients (e.g., cheese, oatmeal, etc.) can be provided.
(14) Nutritional information necessary for individuals can be provided. Information on which nutrients are mainly used in each restaurant can also be provided.
(15) Information on foods that are not useful when consumed together
(16) Information on foods that are useful when consumed together
(17) Changes in nutrients and health precautions when reusing certain foods after refrigeration or freezing
(18) Information on foods that should or should not be consumed depending on health status
(19) Comprehensive provision of foods that are good to consume, foods that are not good to consume, types and times of necessary exercise, recommendations, precautions, etc., in response to an input of an individual's health status
(20) Information on foods that are good against various diseases
(21) Warning if menu selection is inappropriate (assuming there is information on a specific dish of a specific restaurant)
(22) Provision of information on comparison between various opinions on major foods (coffee, milk, etc.) with many opinions on whether they are beneficial or not
(23) Provision of various data to related agencies such as national agencies and food companies
(24) Analysis information of correlation between number of daily meals and health that is obtained by analyzing reports of participants
(25) Provision of information on each ingredient
   5. Useful or Cautionary Information when Cooking
(1) Aluminum foil produces carcinogens when used on food that is cooked by heating.
(2) Participants are encouraged to directly upload various information helpful for cooking such as the above.

### 6. Ways to Activate Information Gathering

(1) Provide rewards when users upload restaurants where they eat, selected dishes, and their features
(2) Provide rewards based on engagement levels and reviews

### 7. Information Management Aspect

(1) Main nutritional components of each food
(2) Recommended daily intake of each nutrient
(3) Symptoms that may appear when specific nutrients are in excess or deficient
(4) Unique features of each restaurant
(5) Information provided by participants

### 8. Subjects of Application

(1) Healthcare
(2) Amounts of ingredients used
(3) Identification of main place of purchase/purchase status/agricultural product distribution flow relating to each ingredient amount
(4) Provision of ingredient consumption patterns by region
(5) Estimation of periods of use of each ingredient through analysis of ingredient purchase patterns

### 9. Elements to be Reflected in Service System

(1) Notification function for recommended and non-recommended foods when there is medication currently being taken
(2) Best recipe and best taste recommended by consumers
(3) A differentiated recipe information collecting method of the present invention: It would be nice if restaurants voluntarily disclosed their recipes, but it is difficult to expect restaurants to disclose their recipes because they are reluctant to expose their trade secrets and think that there is no need to and it is bothersome to disclose their recipes. However, if benefits were provided to restaurants that participated in recipe disclosure, they would also participate voluntarily, and if this changed the overall social atmosphere to the trend of naturally disclosing recipes, all restaurants would have no choice but to participate. One way to provide benefits is to connect a company's advertisements with consumers, provide rewards to consumers who are members who watch the advertisements, and allow the consumers to use these rewards only at restaurants that disclose their recipes, thereby almost forcibly inducing restaurants to disclosure their recipes.
(4) Identity verification function and fashion information collection function using cameras on various devices:
(4-1) Security cameras can be applied to all services where identity (member) verification is possible (e.g., vending machines, robots, etc.), and these cameras can be used to scan the outside of the body of a person during an identity verification procedure and obtain information about that person.
(4-2) Here, the size, shape, etc., of the body can be calculated based on the distance and angle of the subject of scanning to the camera.
(4-3) In case of an emergency in the surrounding area, information can be provided to relevant organizations.
(5) AI-based cooking simulator: Development of an AI cooking simulator that can pre-simulate various factors such as cooking methods, ingredients, water quantity, temperature control, etc., on a computer when attempting to cook at a restaurant, at home, or at another place based on various food-related information available on the present system and the Internet
(6) AI-based cooking robot & system: Development of AI cooking robot & system for linking a dish ordered by a customer at a restaurant to the present system according to the customer's health characteristics and preferences, etc.
(7) A new concept delivery service model that benefits consumers and business owners by utilizing recipe recommendations and advertisements: Introduction of a new delivery business model that can make the most appropriate recommendation by analyzing preferences, health characteristics, recent consumption trends, etc., of consumers and can minimize damage to consumers and business owners by utilizing advertising revenues, breaking away from the existing delivery platform companies that passed on delivery costs to consumers or restaurant owners
(8) Self-certification system and exchange for creative recipes through recipe contests: By providing appropriate compensation to creators, people are encouraged to create and share their recipes through the present service, thereby contributing to providing delicious and healthy food to mankind.
(9) Grouping of people who frequently eat together, such as family and friends, by introducing a friend function: functions of finding, recommending and simulating restaurants to visit together by AI recommending their favorite or common items
(10) Food allergy warning function
(11) Providing levels of various tastes (salty, sweet, sour, bitter, spicy, etc.; analysis through words used by participants who perform evaluation) in graphs
(12) Warning function for the presence of harmful ingredients based on provided genetic characteristics and current health statuses of individuals
(13) Cooking assist function: An assist function that informs a chef or a cook of information on a request made by a consumer to exclude certain ingredients due to food allergies, etc.
(14) Food recall information notification function: A function of gathering food recall and risk information announced by each country's and each region's food-related agency and providing it to consumers of products of concern or consumers in regions of concern

### 10. Method of Disclosing Ingredient (Recipe) Information

(1) A cooking method (boiling, grilling, steaming, warming)
(2) A function of food allergy warning through analysis of ingredient information
(3) Providing levels of various tastes (salty, sweet, sour, bitter, spicy, etc.; analysis through words used by participants who perform evaluation) in graphs
(4) A warning function for dishes containing harmful ingredients based on provided personal health information
(5) An assistant function that informs a chef or a cook of information on a request made by a consumer to exclude certain ingredients due to food allergies, etc.
(6) A function that provides appropriate cooking and eating methods based on health information by focusing on information about ingredients that do not work well together or produce better results when cooked together and how nutrients change depending on cooking methods for each ingredient
(7) Information on storage of ingredients or foods that require special attention
(8) Visualizing and providing various information on eaten foods by day, week, month, etc.
(9) Collecting information on ingredients of manufactured and distributed foods using AI cameras or through information provided on the Internet such as manufacturer sites
(10) Major functions of Internet and mobile sites that are generally operated are included.
(11) A function of informing an individual of whether ingredients to avoid or refrain from, based on genetic health information provided by the individual, are contained
(12) A function of informing an individual of ingredients to actively consume in relation to genetic health information provided by the individual
(13) A function of comparing specific effects of specific components contained in ingredients on health and informing an individual not to overconsume a certain ingredient
(14) All other elements necessary from a healthcare perspective are included.
(15) Using AI, deep learning technology, robot technology, etc., as frequently as possible
(16) A differentiated recipe information collecting method of the present invention: Modern people are very interested in health. Accordingly, they put much effort into managing their health, such as diet management, exercise, taking nutritional supplements, and regular health checkups. Nevertheless, in many cases, people eat food at restaurants without knowing what ingredients are used in the food they eat or how the food is cooked. It would be nice if restaurants voluntarily disclosed their recipes, but it is difficult to expect restaurants to disclose their recipes because they are reluctant to expose their trade secrets and think that there is no need to and it is bothersome to disclose their recipes. However, if benefits were provided to restaurants that participated in recipe disclosure, they would also participate voluntarily, and if this changed the overall social atmosphere to the trend of naturally disclosing recipes, all restaurants would have no choice but to participate. One way to provide benefits is to connect a company's advertisements with consumers, provide rewards to consumers who are members who watch the advertisements, and allow the consumers to use these rewards only at restaurants that disclose their recipes.
(16-1) The expected effects are as follows.
(16-2) An increase in sales can be expected for restaurants that participate in recipe disclosure.
(16-3) Since the rewards from watching advertisements are always reused at restaurants, it leads to the growth of the overall restaurant industry.
(16-4) Consumers can save money through the rewards and can easily identify recipe information, thus being beneficial to not only their physical health but also their mental health.
(16-5) Advertisers can provide customized advertisements to consumers who are members, and since the consumers have no choice but to watch the advertisements to receive rewards, the advertising effect is very good.
(16-6) As a result, this method may almost forcibly make restaurants disclose their recipes or may make restaurants disclose their recipes in a virtuous cycle, which may have a positive effect on society as a whole.
(17) Identity verification function and fashion information collection function using cameras on various devices: Security cameras can be applied to all services where identity (member) verification is possible (e.g., vending machines, robots, etc.), and these cameras can be used to scan the outside of the body of a person during an identity verification procedure and obtain information about the fashion of that person.
(18) AI cooking simulator: Development of an AI cooking simulator that can pre-simulate various factors such as cooking methods, ingredients, water quantity, temperature control, etc., on a computer when attempting to cook at a restaurant, at home, or at another place based on various food-related information available on the present system and the Internet
(19) AI cooking robot: Development of an AI cooking robot that can cook by linking a dish ordered by a customer at a restaurant to the present system according to the customer's health characteristics and preferences, etc.
(20) Copyright of recipe information on sites: Recipe information disclosed on sites and apps is the product of efforts made by operators of the sites, and thus an exclusive copyright for the recipe information itself and processed sources thereof belong to the operators, rather than other companies.
(21) A new concept delivery service model that benefits consumers and business owners by utilizing recipe recommendations and advertisements: Introduction of a new delivery business model that can make the most appropriate recommendation by analyzing preferences, health characteristics, recent consumption trends, etc., of consumers and can minimize damage to consumers and business owners by utilizing advertising revenues, breaking away from the existing delivery platform companies that passed on delivery costs to consumers or restaurant owners

### 11. Constitution of the Invention

### (1) Collection of Menu Information and Ingredient Information on Dishes for Each Restaurant

Menu information and ingredient information on dishes are received for each restaurant in map data from a user terminal or a restaurant terminal. When the menu information and the ingredient information are directly received from the restaurant terminal, the menu information and the ingredient information are information directly authenticated by the restaurant. When the menu information and the ingredient information are received from the user terminal, the menu information and the ingredient information are authenticated as reliable information according to a ratio of the number of likes received from multiple other user terminals. Weighted values vary according to the ratio of the number of likes received from people. The likes on the corresponding restaurant have the highest weighted value. The next highest weighted values are assigned according to the history of providing menu information and the menu information that has actually been chosen so far. The weighted value increases with an increase in the number of dish proposals, and the weighted value further increases according to the number of times a dish among the proposed dishes is actually selected as corresponding to ingredients of food.

### (2) Collection of Restaurant Meal Information for Each User

Information on a dish eaten at a restaurant is received from a user terminal. A method of receiving information on an eaten dish corresponds to any one of the following.

(2-1) An input on a selected dish is directly received from a user after the user selects a restaurant.

(2-2) A photo of food taken at a restaurant is received from a user, and the corresponding photo is analyzed to recognize a dish closest to the food in the photo from menu information of the corresponding restaurant. A confirmation that the corresponding dish is correct or a dish correction is received from the user.

(2-3) A user sends a dish order to a restaurant terminal through an application of a management server. In this case, the management server may send payment information on the dish order to the restaurant terminal through a payment gateway. The operating principle is the same as a delivery app except that food is eaten directly at a restaurant.

(2-4) Otherwise, photos of product information and nutritional information may be received from a user and recognized when the user purchases and eats processed food at a convenience store, etc.

### (3) Analysis of Consumed Food Information and Provision of Nutritional Information for Each User

Analysis information on foods that a user has consumed in the meantime is provided by day, week, month, quarter, year, or set period or according to a request from the user.

Information on restaurants that a user frequently visits, information on dishes that the user frequently purchases, ingredient information of food frequently consumed by the user, and nutritional information of the food are provided.

Based on personal information (sex, age, height, weight) and health information (preexisting conditions, special circumstances) input by the user, information on whether the analyzed nutritional intake habits are appropriate for the user is provided.

### (4) Provision of Recommendation Information on Restaurants and Dishes

(4-1) When information about where a user will eat or information on the current location of the user is received from the user, based on personal information (sex, age, height, weight) and health information (preexisting conditions, special circumstances) input by the user, recommendation information on restaurants and dishes that are more suitable for the user's health status among restaurants within a set radius centered on the corresponding location is provided.

(4-2) When the user has already entered a restaurant, recommendation information on a dish that is the most suitable for the user's health status among a plurality of dishes set for the restaurant is provided.

(4-3) Food allergy notification, a function that informs whether harmful ingredients are used in relation to a specific person's health information

### (5) Inducing Restaurant Managers to Voluntarily Provide Information

(5-1) A service in which advertising revenues of another service in operation are utilized to provide point rewards to members, a benefit allowing the members to use the point rewards to pay for food at affiliated restaurants is provided to the members, promotion for the members of the service is provided to restaurants, and managers of the restaurants are encouraged to disclose ingredient information, nutritional information, cooking method information, etc., relating to food

(5-2) Benefits may be given to consumers, and business revitalization or damage minimization may occur for restaurants. For example, it is possible to prevent a significant decrease in profits of restaurants due to increased costs and other reasons caused by delivery fees that arise when managers of the restaurants use food delivery apps.

(6) A Function of Grouping People Who Frequently Eat Together, Such as Family and Friends, and Recommending Dishes at their Favorite Restaurants or Common Items

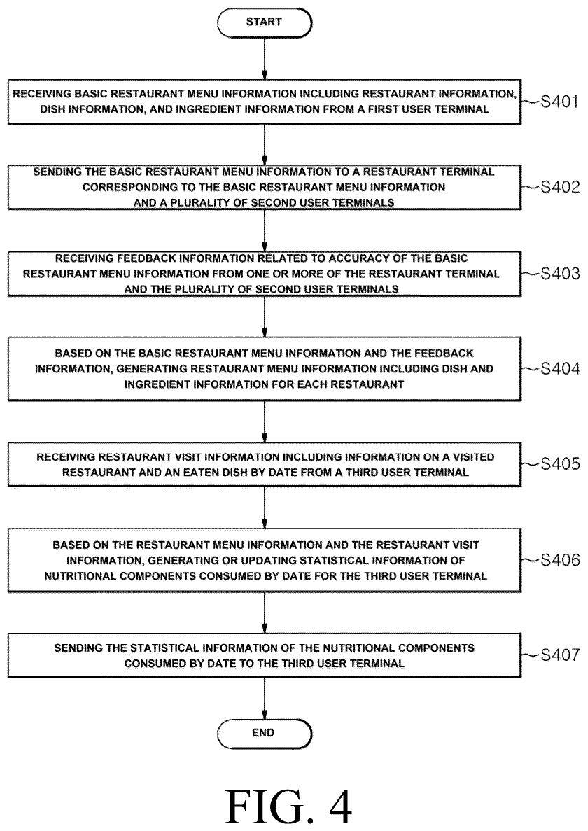

FIG. 4 illustrates an operation process of the server according to various embodiments of the present invention.

In an embodiment of FIG. 4, a server includes a transceiver, a memory, and a processor.

Referring to FIG. 4, in step S401, the server receives basic restaurant menu information including restaurant information, dish information, and ingredient information from a first user terminal through the transceiver.

In step S402, the server sends the basic restaurant menu information to a restaurant terminal corresponding to the basic restaurant menu information and a plurality of second user terminals through the transceiver.

In step S403, the server receives feedback information related to accuracy of the basic restaurant menu information from one or more of the restaurant terminal and the plurality of second user terminals through the transceiver.

In step S404, based on the basic restaurant menu information and the feedback information, the server generates restaurant menu information including dish and ingredient information for each restaurant through the processor.

In step S405, the server receives restaurant visit information including information on a visited restaurant and an eaten dish by date from a third user terminal through the transceiver.

In step S406, based on the restaurant menu information and the restaurant visit information, the server generates or updates statistical information of nutritional components consumed by date for the third user terminal through the processor.

In step S407, the server sends the statistical information of the nutritional components consumed by date to the third user terminal through the transceiver.

According to various embodiments of the present invention, the embodiment of FIG. 4 may further include a process of receiving a dish order request including information on a dish relating to the visited restaurant from the third user terminal through the transceiver; a process of sending the dish order request of the third user terminal to the restaurant terminal corresponding to the restaurant through the transceiver; a process of receiving a confirmation response to the dish order request from the restaurant terminal through the transceiver; a process of sending the confirmation response to the third user terminal through the transceiver; a process of, based on the dish order request, generating or updating the statistical information of the nutritional components consumed by date relating to the third user terminal through the processor; a process of receiving payment information corresponding to the dish order request from the third user terminal through the transceiver; and a process of sending the payment information to the restaurant terminal through the transceiver.

According to various embodiments of the present invention, the embodiment of FIG. 4 may further include a process of receiving user health-related information from the third user terminal through the transceiver; a process of, based on the user health-related information, generating one or more of information on recommended nutritional components and recommended nutritional ingredients corresponding to the third user terminal and information on nutritional components to avoid or nutritional ingredients to avoid corresponding to the third user terminal through the processor; a process of receiving location information of the third user terminal from the third user terminal through the transceiver; a process of, based on the one or more of the information on the recommended nutritional components and the recommended nutritional ingredients and the information on the nutritional components to avoid or the nutritional ingredients to avoid, determining a dish to recommend to the third user terminal among dishes of restaurants within a set range based on the location of the third user terminal through the processor; a process of sending the recommended dish and restaurant information corresponding to the recommended dish to the third user terminal through the transceiver; a process of receiving a request for visited restaurant menu information corresponding to a visited restaurant from the third user terminal through the transceiver; a process of sending the visited restaurant menu information corresponding to the visited restaurant among the restaurant menu information to the third user terminal through the transceiver; a process of, based on the one or more of the information on the recommended nutritional components and the recommended nutritional ingredients and the information on the nutritional components to avoid or the nutritional ingredients to avoid, sending information on a recommended dish or a non-recommended dish among the visited restaurant menu information to the third user terminal through the transceiver; a process of receiving information on a specific dish selected among the visited restaurant menu information and information on a request to add or exclude an ingredient from the third user terminal through the transceiver; and a process of sending the information on the selected specific dish and the information on the request to add or exclude the ingredient to the restaurant terminal through the transceiver.

According to various embodiments of the present invention, the restaurant information among the basic restaurant menu information may be configured to be selected among restaurants registered in a restaurant portal database. The restaurant menu information may be newly generated or selected among previously generated menu information. The ingredient information may be configured in the form of text. The restaurant menu information may correspond to information verified based on the feedback information among the basic restaurant menu information. The feedback information may be configured with one or more of information of a photo of a menu on which dish and ingredient information is written, information of a confirmation of the basic restaurant menu information from the restaurant terminal, and positive or negative feedback on the basic restaurant menu information from the plurality of second user terminals that correspond to a plurality of users who have visited the restaurant corresponding to the basic restaurant menu information. When verification of the basic restaurant menu information is based on the positive or negative feedback on the basic restaurant menu information from the plurality of users who have visited the restaurant, the verification of the basic restaurant menu information may be performed based on whether positive feedback accounts for a critical proportion or more.

According to various embodiments of the present invention, when the verification of the basic restaurant menu information is based on the positive or negative feedback on the basic restaurant menu information from the plurality of second user terminals that correspond to the plurality of users who have visited the restaurant, the verification may be performed when the total amount of feedback, including positive or negative feedback, is a critical amount of feedback or more.

According to various embodiments of the present invention, the critical amount of feedback may be based on a product of an information provider weighted value relating to the first user terminal and a set reference critical amount of feedback.

According to various embodiments of the present invention, the information provider weighted value may be set to decrease with an increase in the number of results verified to be accurate among previously provided basic restaurant menu information of the first user terminal.

According to various embodiments of the present invention, the information provider weighted value may be set to increase with an increase in the number of results verified to be inaccurate among the previously provided basic restaurant menu information of the first user terminal.

According to various embodiments of the present invention, when the total amount of feedback is the critical amount of feedback or more and positive feedback scores account for the critical proportion or more relative to negative feedback scores, the basic restaurant menu information may be verified as accurate.

According to various embodiments of the present invention, when the total amount of feedback is the critical amount of feedback or more and the positive feedback scores account for less than the critical proportion relative to the negative feedback scores, the basic restaurant menu information may be verified as inaccurate.

According to various embodiments of the present invention, the positive feedback scores or the negative feedback scores may each be based on a product of a feedback provider weighted value set for each of the plurality of second user terminals and a set reference feedback score.

According to various embodiments of the present invention, when the verification of the basic restaurant menu information is based on the positive or negative feedback on the basic restaurant menu information by the plurality of users who have visited the restaurant, the feedback provider weighted value set for each of the plurality of second user terminals may be set to be higher when receipt information on the basic restaurant menu information at the restaurant is received from each of the plurality of second user terminals. In addition, the feedback provider weighted value set for each of the plurality of second user terminals may be set to be higher when payment information on the basic restaurant menu information is sent from each of the plurality of second user terminals to the restaurant terminal through the server. In addition, the feedback provider weighted value set for each of the plurality of second user terminals may be set to be higher when each of the plurality of second user terminals is a terminal corresponding to a food expert set by the server. In addition, the feedback provider weighted value set for each of the plurality of second user terminals may be set to be higher with an increase in the amount of feedback verified to be accurate among previous feedback on other basic restaurant menu information by each of the plurality of second user terminals.

According to various embodiments of the present invention, the embodiment of FIG. 4 may further include a process of receiving the restaurant information and the dish information from the first user terminal through the transceiver; a process of, based on the dish information and food photo information, generating predicted ingredient information through the processor, the predicted ingredient information including ingredient information previously verified in relation to a dish that is the same as or similar to that indicated in the dish information; a process of sending the predicted ingredient information to the first user terminal through the transceiver; and a process of receiving basic restaurant menu information including the ingredient information from the first user terminal through the transceiver. The ingredient information may include information on ingredients added to the predicted ingredient information and ingredients removed from the predicted ingredient information.

According to various embodiments of the present invention, the embodiment of FIG. 4 may further include a process of receiving information on a plurality of fourth user terminals grouped with the third user terminal from the third user terminal through the transceiver; a process of receiving second restaurant visit information including information on a visited restaurant and an eaten dish by date from the plurality of fourth user terminals through the transceiver; a process of receiving a request for information on one or more recommended restaurants to visit together with one or more fourth user terminals among the plurality of fourth user terminals and one or more recommended dishes from the third user terminal through the transceiver; a process of, based on the restaurant visit information and the second restaurant visit information, generating information on one or more recommended restaurants relating to a specific region and one or more recommended dishes corresponding to the one or more restaurants through the processor, the one or more recommended dishes corresponding to common dishes among previously eaten dishes of the third user terminal and previously eaten dishes of the one or more fourth user terminals based on the restaurant visit information and the second restaurant visit information, and the one or more recommended restaurants being one or more restaurants corresponding to the common dishes within the specific region; a process of sending the information on the one or more recommended restaurants and the one or more recommended dishes to the third user terminal through the transceiver; a process of receiving third restaurant visit information including information on a restaurant that the third user terminal and the one or more fourth user terminals have visited together and an eaten dish from the third user terminal through the transceiver; a process of receiving a request for statistical information of nutritional components consumed on a date on which a restaurant is visited together with the third user terminal for each of the plurality of fourth user terminals from the third user terminal through the transceiver; and a process of sending the statistical information of the nutritional components consumed on the date on which a restaurant is visited together with the third user terminal for each of the plurality of fourth user terminals to the third user terminal through the transceiver.

According to various embodiments of the present invention, the embodiment of FIG. 4 may further include, when the feedback information is based on confirmation of the basic restaurant menu information of the restaurant terminal, a process of sending a message asking whether to approve or disapprove use of reward points of a service run by the server to pay for food to the restaurant terminal through the transceiver; a process of receiving a response message approving the use of the reward points to pay for food from the restaurant terminal through the transceiver; and a process of sending the basic restaurant menu information and information informing that it is possible to use the reward points of the service to pay for food to a plurality of fifth user terminals subscribed to the service run by the server through the transceiver. The service run by the server may correspond to another service run on a membership basis.

According to various embodiments of the present invention, the basic restaurant menu information and the restaurant menu information may further include information of a recipe for each dish.

According to various embodiments of the present invention, the embodiment of FIG. 4 may further include a process of receiving a request for the restaurant menu information corresponding to a currently visited restaurant from the third user terminal through the transceiver; a process of sending the restaurant menu information corresponding to the currently visited restaurant to the third user terminal through the transceiver; a process of, based on a recipe for each dish included in the restaurant menu information, receiving a message requesting a cooking simulation of a simulation recipe identical to the recipe for each dish or a simulation recipe obtained by partially modifying the recipe for each dish from the third user terminal through the transceiver; a process of, based on the simulation recipe, generating cooking simulation information through the processor; a process of sending the cooking simulation information to the third user terminal through the transceiver; a process of receiving dish order information based on the cooking simulation information from the third user terminal through the transceiver; and a process of sending dish order information including a recipe based on the cooking simulation information to the restaurant terminal corresponding to the currently visited restaurant through the transceiver.

According to various embodiments of the present invention, the recipe for each dish may include the types and conditions of ingredients, cooking utensils, a cooking order, a cooking time, a cooking temperature, seasonings, and spices. The cooking simulation information may include an appearance, a taste, a flavor, nutritional information, and mouthfeel of a cooked dish. The memory may include a trained AI cooking simulation model. The cooking simulation information may be generated based on the AI cooking simulation model.

According to various embodiments of the present invention, the method of FIG. 4 may further include a process of receiving a request for proposal of a recipe for a specific dish among the dishes included in the restaurant menu information from the third user terminal; a process of generating cooking simulation information on the recipe for each dish that relates to the specific dish through the processor; a process of, based on the information on the eaten dishes that is previously received from the third user terminal, generating statistical cooking simulation information on the previously eaten dishes through the processor; a process of, based on the statistical cooking simulation information, determining frequently consumed taste and nutrition in relation to taste and nutrition of the previously eaten dishes; a process of, for taste and nutrition simulated based on the cooking simulation to be close to the frequently consumed taste and nutrition, generating information of a proposed recipe that is obtained by partially modifying the recipe for each dish that relates to the specific dish, where the taste and nutrition simulated based on the proposed recipe are closer to the frequently consumed taste and nutrition than taste and nutrition simulated based on the recipe for each dish that relates to the specific dish; a process of sending the information of the proposed recipe to the third user terminal; a process of receiving dish order information based on the proposed recipe from the third user terminal through the transceiver; and a process of sending the dish order information including the proposed recipe to the restaurant terminal corresponding to the currently visited restaurant through the transceiver.

When generating an AI-based cooking simulation, the following factors may be considered to improve accuracy and practicality of simulation.
1. Types and conditions of ingredients: The freshness, size, and cutting method (e.g., shredding, chopping) of each ingredient greatly affects the taste and texture of a dish.
2. Cooking utensils and cooking vessels: The type and size of a pan, a pot, an oven, etc., being used also affect a cooking result.
3. Cooking order: An order in which ingredients are added has a significant impact on taste and texture.
4. Cooking time: A cooking time at each step is critical for the texture and flavor of food.
5. Temperature: Changes in temperatures of ingredients or a cooking environment during a cooking process are very important.
6. Seasonings and spices: The types and amounts of salt, pepper, herbs, spices, etc., should also be included.
7. Technical manipulation: Specific cooking techniques such as stirring, turning over, and pressing may be required in some cases.
8. Mouthfeel and color: It is also important to predict the mouthfeel and color of the final food.
9. Nutritional information: Estimating the nutrient content of each ingredient and the nutritional changes after cooking may also be useful.
10. Safety and hygiene: Food safety and hygienic handling methods should also be considered.

Incorporating these factors into simulation allows AI to make predictions that are more accurate and closer to the actual cooking process.

Factors that need to be included in cooking simulation result information may vary according to simulation purposes and user needs. However, some factors that may generally be considered important are:
1: Final food appearance: Simulation can provide a visual representation of what the food will look like when cooking is complete. This may include color, texture, shape, etc.
2. Anticipated taste and flavor: Sensory characteristics such as the flavor, smell, bitterness, sweetness, saltiness, and spiciness may be predicted and explained.
3. Nutritional information: Nutrient content such as calories, protein, fat, carbohydrates, vitamins, and minerals of a cooked dish may be provided.
4. Texture and structure: Information on texture such as mouthfeel, softness, and chewiness may be included.
5. Cooking time and cooking difficulty level: The time taken for the entire cooking process and the difficulty level or complexity of cooking may be evaluated.
6. Safety and hygiene guidelines: Information on food safety-related precautions or hygienic cooking methods may be provided.
7. Variability and flexibility: Guidance on replaceability of ingredients, changes in results according to various cooking methods, etc., may be provided.
8. Cost estimation: Estimated values of ingredient costs and the overall cooking cost may be provided.
9. User feedback option: It may also be useful to include a function that allows a user to provide feedback on simulation results.
10. Impact on the environment: Evaluation of impact of cooking processes on the environment, in terms of carbon footprint or sustainability, may be included.

The above information helps a user better understand a cooking process and effectively apply knowledge obtained through simulation to the actual cooking.

AI model construction and training is a very important part in cooking simulations using a computer. This process can mainly be divided into data collection, model design, model training, and evaluation and optimization steps. Processes necessary for each step will be described below.

### 1. Data Collection and Pre-Processing

(1) Data to be collected: This includes various cooking information such as recipes, ingredients, cooking methods, cooking times, etc. This can be collected from online recipe databases, cooking books, cooking-related forums and blogs, etc.

(2) Data preprocessing: The collected data is converted into a form that can be understood by a model. For example, tasks such as tokenizing text data, standardizing amounts of ingredients, and classifying recipes by step are included.

### 2. Model Design

(1) Model type selection: An AI model suitable for cooking simulation is selected. For example, a recurrent neural network (RNN) or a transformer model may be useful in modeling sequential cooking steps.

(2) Network architecture: The layer, the number of neurons, the activation function, etc., of a model are determined. These may vary according to the purpose and complexity of cooking simulation.

### 3. Model Training

(1) Training data preparation: The preprocessed data is divided into training, verification, and test sets.

(2) Setting of training parameters: Parameters necessary for training, such as a training rate, an arrangement size, and the number of epochs, are set.

(3) Training process: A model is trained to learn a pattern from the training data. This process is generally performed across several epochs.

### 4. Evaluation and Optimization

(1) Performance evaluation: Performance of a model is evaluated using a verification data set. This is used to determine how accurately the model simulates the process and result of cooking.

(2) Optimization: The model is adjusted to prevent overfitting and improve generalization performance. For example, dropout, a normalization technique, etc., may be used.

(3) Test: The final model is applied to a test data set to evaluate the actual performance.

### 5. Other Things to Consider

(1) Diversity and comprehensibility: Data reflecting various cooking styles and cultures is collected to improve universality of a model.

(2) Real-time feedback: Real-time feedback from a user is included in model training to improve adaptability and accuracy of a model.

An AI model constructed through these processes plays a very important role in cooking simulation. The quality of a simulation experience provided to a user may greatly depend on the accuracy and reliability of the model.

According to various embodiments of the present invention, some or all of the first user terminal, the plurality of second user terminals, the third user terminal, the plurality of fourth user terminals, and the plurality of fifth user terminals may correspond to terminals identical to each other in some cases or may correspond to terminals different from each other in some cases. For example, the first user terminal collecting the basic restaurant menu information may correspond to a restaurant terminal operated by a restaurant manager, and the second user terminal confirming the basic restaurant menu information and providing feedback thereon may also correspond to the restaurant terminal. In this case, the restaurant menu information is provided to the server and confirmed by the restaurant terminal itself operated by the restaurant manager. The plurality of fifth user terminals subscribed to another service run by the server may correspond to some or all of the first user terminal, the plurality of second user terminals, the third user terminal, and the plurality of fourth user terminals.

Various embodiments of the present invention provide a server in a communication system. The server includes a transceiver, a memory, and a processor, and the processor is configured to perform an operation method of the server in the communication system according to various embodiments of the present invention.

Various embodiments of the present invention provide a computer program recorded in a computer readable recording medium. The computer program is configured to perform an operation method of a server in a communication system according to various embodiments of the present invention.

When an embodiment of the present invention is implemented using hardware, application specific integrated circuits (ASICs), digital signal processors (DSPs), digital signal processing devices (DSPDs), programmable logic devices (PLDs), field programmable gate arrays (FPGAs), etc., configured to perform the present invention may be disposed in the processor of the present invention.

The present invention can provide a method and apparatus for collecting ingredient information for each dish at a restaurant and providing information on nutrients consumed by date based on restaurant visit information.

The present invention can provide a method and apparatus for verifying basic information for each dish at an individual restaurant collected from a first user based on feedback from a plurality of second users, confirmation from restaurant managers, etc., thereby collecting ingredient information for each dish at the individual restaurant and providing information on nutrients consumed by date based on restaurant visit information of a third user.

The present invention can provide a method and apparatus that help a user identify the exact ingredients and nutritional information of dishes at a restaurant and easily select a diet suitable for his or her health status.

The present invention can provide a method and apparatus for verifying ingredient information through feedback on menu information collected from a plurality of users and confirmation from restaurant managers and providing personalized nutritional information based on meal records and health data of a user.

The present invention can provide a method and apparatus capable of recommending a restaurant that provides a dish using ingredients recommended for a user based on health information and position information of the user.

The present invention can provide a method and apparatus for providing an opportunity to use reward points based on a service run by a server to pay for food in restaurants that collaborate to secure accurate information of ingredients for each dish and providing an influx of users of the service to the restaurants, thereby identifying the exact ingredients and nutritional information of dishes at restaurants.

The present invention can provide a method and apparatus for assigning different weighted values based on past history of each user for those providing basic restaurant menu information or those providing feedback information on accuracy of the basic restaurant menu information, thereby promoting efficiency of sorting out accurate information.

The present invention can provide a method and apparatus for, when a user is to visit a restaurant together with other users who are grouped with the user through a combination of nutritional management and a social network, generating information of restaurants that provide common dishes among dishes previously eaten by the users who are to visit the restaurant together and providing information of recommended restaurants and recommended dishes, and to each of the other users who are grouped with the user, providing information on nutrients consumed on the date on which he or she visited the restaurant together with the user.

The present invention can provide a method and apparatus allowing a user to, based on recipe information for each dish at restaurants collected from users, receive cooking simulation information relating to an appearance, a taste, a nutritional state, etc., of food as a result of cooking based on a unique recipe of a restaurant or a partially modified recipe through an AI-based cooking simulation model, and allowing the user to order food based on the unique recipe of the restaurant or the partially modified recipe.

The present invention can provide a method and apparatus for, based on information of previously eaten dishes that is received from a user, proposing a modified recipe for a specific dish at a restaurant that the user is currently visiting for the taste and nutrition of the specific dish to be close to frequently consumed taste and nutrition based on cooking simulations of the previously eaten dishes and allowing the user to order food based on the proposed recipe.

Meanwhile, the above-described method can be written by a computer executable program and may be implemented in a universal digital computer running the program using computer readable media. In addition, structures of data used in the above-described method may be recorded through various means in computer readable storage media. Program storage devices that may be used to describe storage devices including executable computer codes for performing various methods of the present invention should not be understood as including temporary objects such as carrier waves or signals. The computer readable storage media include storage media such as magnetic storage media (e.g., a read-only memory (ROM), a floppy disk, a hard disk, etc.) and optical readable media (e.g., a CD-ROM, DVD, etc.).

The embodiments described above are those in which components and features of the present invention are combined in a predetermined form. Each component or feature should be considered optional unless explicitly stated otherwise. Each component or feature may be implemented in a form that is not combined with other components or features. In addition, it is also possible to constitute an embodiment of the present invention by combining some components and/or features. The order of operations described in the embodiments of the present invention may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

It will be apparent to those skilled in the art to which the present invention pertains that the present invention may be embodied in different forms without departing from the technical spirit and essential features of the present invention. The above embodiments are therefore to be construed in all aspects as illustrative and not restrictive. The scope of rights of the present invention should be determined by rational interpretation of the appended claims and all modifications possible within an equivalent scope of the present invention.

What is claimed is:

1. A method of operation of a server in a communication system in which the server includes a transceiver, a memory, and a processor, the method comprising:
a process of receiving basic restaurant menu information including restaurant information, dish information, and ingredient information from a first user terminal through the transceiver;
a process of sending the basic restaurant menu information to a restaurant terminal corresponding to the basic restaurant menu information and a plurality of second user terminals through the transceiver;
a process of receiving feedback information related to accuracy of the basic restaurant menu information from one or more of the restaurant terminal and the plurality of second user terminals through the transceiver;
a process of, based on the basic restaurant menu information and the feedback information, generating restaurant menu information including dish and ingredient information for each restaurant through the processor;
a process of receiving restaurant visit information including information on a visited restaurant and an eaten dish by date from a third user terminal through the transceiver;
a process of, based on the restaurant menu information and the restaurant visit information, generating or updating statistical information of nutritional components consumed by date for the third user terminal through the processor; and
a process of sending the statistical information of the nutritional components consumed by date to the third user terminal through the transceiver,
wherein the restaurant menu information corresponds to information verified based on the feedback information among the basic restaurant menu information,
the feedback information is based on one or more of information of a photo of a menu on which dish and ingredient information is written, information of a confirmation of the basic restaurant menu information from the restaurant terminal, and positive or negative feedback on the basic restaurant menu information from the plurality of second user terminals that correspond to a plurality of users who have visited the restaurant corresponding to the basic restaurant menu information,
when verification of the basic restaurant menu information is based on the positive or negative feedback on the basic restaurant menu information from the plurality of second user terminals that correspond to the plurality of users who have visited the restaurant, the verification is performed when the total amount of feedback, including positive or negative feedback, is a critical amount of feedback or more, and the verification is performed based on whether positive feedback accounts for a critical proportion or more,
the critical amount of feedback is based on a product of an information provider weighted value relating to the first user terminal and a set reference critical amount of feedback,
the information provider weighted value is set to decrease with an increase in the number of results verified to be accurate among previously provided basic restaurant menu information of the first user terminal,
the information provider weighted value is set to increase with an increase in the number of results verified to be inaccurate among the previously provided basic restaurant menu information of the first user terminal,
when the total amount of feedback is the critical amount of feedback or more and positive feedback scores account for the critical proportion or more relative to negative feedback scores, the basic restaurant menu information is verified as accurate,
when the total amount of feedback is the critical amount of feedback or more and the positive feedback scores account for less than the critical proportion relative to the negative feedback scores, the basic restaurant menu information is verified as inaccurate, and
the positive feedback scores or the negative feedback scores are each based on a product of a feedback provider weighted value set for each of the plurality of second user terminals and a set reference feedback score.

2. The method of claim 1, further comprising:
a process of, after the sending of the statistical information of the nutritional components consumed by date to the third user terminal through the transceiver, receiving a dish order request including information on a dish relating to the visited restaurant from the third user terminal through the transceiver;
a process of sending the dish order request of the third user terminal to the restaurant terminal corresponding to the restaurant through the transceiver;
a process of receiving a confirmation response to the dish order request from the restaurant terminal through the transceiver;
a process of sending the confirmation response to the third user terminal through the transceiver;
a process of, based on the dish order request, generating or updating the statistical information of the nutritional components consumed by date relating to the third user terminal through the processor;
a process of receiving payment information corresponding to the dish order request from the third user terminal through the transceiver; and
a process of sending the payment information to the restaurant terminal through the transceiver.

3. The method of claim 1, further comprising:
a process of, after the sending of the statistical information of the nutritional components consumed by date to the third user terminal through the transceiver, receiving user health-related information from the third user terminal through the transceiver;
a process of, based on the user health-related information, generating one or more of information on recommended nutritional components and recommended nutritional ingredients corresponding to the third user terminal and information on nutritional components to avoid or nutritional ingredients to avoid corresponding to the third user terminal through the processor;
a process of receiving location information of the third user terminal from the third user terminal through the transceiver;
a process of, based on the one or more of the information on the recommended nutritional components and the recommended nutritional ingredients and the information on the nutritional components to avoid or the nutritional ingredients to avoid, determining a dish to recommend to the third user terminal among dishes of restaurants within a set range based on the location of the third user terminal through the processor;
a process of sending the recommended dish and restaurant information corresponding to the recommended dish to the third user terminal through the transceiver;
a process of receiving a request for visited restaurant menu information corresponding to a visited restaurant from the third user terminal through the transceiver;
a process of sending the visited restaurant menu information corresponding to the visited restaurant among the restaurant menu information to the third user terminal through the transceiver;
a process of, based on the one or more of the information on the recommended nutritional components and the recommended nutritional ingredients and the information on the nutritional components to avoid or the nutritional ingredients to avoid, sending information on a recommended dish or a non-recommended dish among the visited restaurant menu information to the third user terminal through the transceiver;
a process of receiving information on a specific dish selected among the visited restaurant menu information and information on a request to add or exclude an ingredient from the third user terminal through the transceiver; and
a process of sending the information on the selected specific dish and the information on the request to add or exclude the ingredient to the restaurant terminal through the transceiver.

4. The method of claim 1, further comprising:
a process of, after the sending of the statistical information of the nutritional components consumed by date to the third user terminal through the transceiver, receiving information on a plurality of fourth user terminals grouped with the third user terminal from the third user terminal through the transceiver;
a process of receiving second restaurant visit information including information on a visited restaurant and an eaten dish by date from the plurality of fourth user terminals through the transceiver;
a process of receiving a request for information on one or more recommended restaurants to visit together with one or more fourth user terminals among the plurality of fourth user terminals and one or more recommended dishes from the third user terminal through the transceiver;
a process of, based on the restaurant visit information and the second restaurant visit information, generating information on one or more recommended restaurants relating to a specific region and one or more recommended dishes corresponding to the one or more restaurants through the processor, the one or more recommended dishes corresponding to common dishes among previously eaten dishes of the third user terminal and previously eaten dishes of the one or more fourth user terminals based on the restaurant visit information and the second restaurant visit information, and the one or more recommended restaurants being one or more restaurants corresponding to the common dishes within the specific region;
a process of sending the information on the one or more recommended restaurants and the one or more recommended dishes to the third user terminal through the transceiver;
a process of receiving third restaurant visit information including information on a restaurant that the third user terminal and the one or more fourth user terminals have visited together and an eaten dish from the third user terminal through the transceiver;
a process of receiving a request for statistical information of nutritional components consumed on a date on which a restaurant is visited together with the third user terminal for each of the plurality of fourth user terminals from the third user terminal through the transceiver; and
a process of sending the statistical information of the nutritional components consumed on the date on which a restaurant is visited together with the third user terminal for each of the plurality of fourth user terminals to the third user terminal through the transceiver.

5. The method of claim 1, wherein the restaurant information among the basic restaurant menu information is configured to be selected among restaurants registered in a restaurant portal database, the restaurant menu information is newly generated or selected among previously generated menu information, and the ingredient information is configured in the form of text, and
when the feedback information is based on confirmation of the basic restaurant menu information of the restaurant terminal,
the method further comprises:
a process of, after the sending of the statistical information of the nutritional components consumed by date to the third user terminal through the transceiver, sending a message asking whether to approve or disapprove use of reward points of a service run by the server to pay for food to the restaurant terminal through the transceiver;
a process of receiving a response message approving the use of the reward points to pay for food from the restaurant terminal through the transceiver; and
a process of sending the basic restaurant menu information and information informing that it is possible to use the reward points of the service to pay for food to a plurality of fifth user terminals subscribed to the service run by the server through the transceiver.

6. The method of claim 1, wherein the feedback provider weighted value set for each of the plurality of second user terminals is:
set to be higher when receipt information on the basic restaurant menu information at the restaurant is received from each of the plurality of second user terminals;
set to be higher when payment information on the basic restaurant menu information is sent from each of the plurality of second user terminals to the restaurant terminal through the server;
set to be higher when each of the plurality of second user terminals is a terminal corresponding to a food expert set by the server; or
set to be higher with an increase in the amount of feedback verified to be accurate among previous feedback on other basic restaurant menu information by each of the plurality of second user terminals.

7. The method of claim 1, wherein the basic restaurant menu information and the restaurant menu information further include information of a recipe for each dish,
the method further comprises:
a process of, after the sending of the statistical information of the nutritional components consumed by date to the third user terminal through the transceiver, receiving a request for the restaurant menu information corresponding to a currently visited restaurant from the third user terminal through the transceiver;
a process of sending the restaurant menu information corresponding to the currently visited restaurant to the third user terminal through the transceiver;
a process of, based on the recipe for each dish included in the restaurant menu information, receiving a message requesting a cooking simulation of a simulation recipe identical to the recipe for each dish or a simulation recipe obtained by partially modifying the recipe for each dish from the third user terminal through the transceiver;
a process of, based on the simulation recipe, generating cooking simulation information through the processor;
a process of sending the cooking simulation information to the third user terminal through the transceiver;
a process of receiving dish order information based on the cooking simulation information from the third user terminal through the transceiver; and
a process of sending dish order information including a recipe based on the cooking simulation information to the restaurant terminal corresponding to the currently visited restaurant through the transceiver,
the recipe for each dish includes types and conditions of ingredients, cooking utensils, a cooking order, a cooking time, a cooking temperature, seasonings, and spices,
the cooking simulation information includes an appearance, a taste, a flavor, nutritional information, and mouthfeel of a cooked dish,
the memory includes a trained artificial intelligence (AI) cooking simulation model, and
the cooking simulation information is generated based on the AI cooking simulation model.

8. The method of claim 7, further comprising:
a process of, after the sending of the statistical information of the nutritional components consumed by date to the third user terminal through the transceiver, receiving a request for proposal of a recipe for a specific dish among the dishes included in the restaurant menu information from the third user terminal;
a process of generating cooking simulation information on the recipe for each dish that relates to the specific dish through the processor;
a process of, based on the information on the eaten dishes that is previously received from the third user terminal, generating statistical cooking simulation information on the previously eaten dishes through the processor;
a process of, based on the statistical cooking simulation information, determining frequently consumed taste and nutrition in relation to taste and nutrition of the previously eaten dishes;
a process of, for taste and nutrition simulated based on the cooking simulation to be close to the frequently consumed taste and nutrition, generating information of a proposed recipe that is obtained by partially modifying the recipe for each dish that relates to the specific dish, where the taste and nutrition simulated based on the proposed recipe are closer to the frequently consumed taste and nutrition than taste and nutrition simulated based on the recipe for each dish that relates to the specific dish;
a process of sending the information of the proposed recipe to the third user terminal;
a process of receiving dish order information based on the proposed recipe from the third user terminal through the transceiver; and
a process of sending the dish order information including the proposed recipe to the restaurant terminal corresponding to the currently visited restaurant through the transceiver.

9. A server in a communication system, the server comprising a transceiver, a memory, and a processor, wherein the processor is configured to:
receive basic restaurant menu information including restaurant information, dish information, and ingredient information from a first user terminal through the transceiver;
send the basic restaurant menu information to a restaurant terminal corresponding to the basic restaurant menu information and a plurality of second user terminals through the transceiver;
receive feedback information related to accuracy of the basic restaurant menu information from one or more of the restaurant terminal and the plurality of second user terminals through the transceiver;
based on the basic restaurant menu information and the feedback information, generate restaurant menu information including dish and ingredient information for each restaurant through the processor;
receive restaurant visit information including information on a visited restaurant and an eaten dish by date from a third user terminal through the transceiver;
based on the restaurant menu information and the restaurant visit information, generate or update statistical information of nutritional components consumed by date for the third user terminal through the processor; and
send the statistical information of the nutritional components consumed by date to the third user terminal through the transceiver,
the restaurant menu information corresponds to information verified based on the feedback information among the basic restaurant menu information,
the feedback information is based on one or more of information of a photo of a menu on which dish and ingredient information is written, information of a confirmation of the basic restaurant menu information from the restaurant terminal, and positive or negative feedback on the basic restaurant menu information from the plurality of second user terminals that correspond to a plurality of users who have visited the restaurant corresponding to the basic restaurant menu information,
when verification of the basic restaurant menu information is based on the positive or negative feedback on the basic restaurant menu information from the plurality of second user terminals that correspond to the plurality of users who have visited the restaurant, the verification is performed when the total amount of feedback, including positive or negative feedback, is a critical amount of feedback or more, and the verification is performed based on whether positive feedback accounts for a critical proportion or more,
the critical amount of feedback is based on a product of an information provider weighted value relating to the first user terminal and a set reference critical amount of feedback,
the information provider weighted value is set to decrease with an increase in the number of results verified to be accurate among previously provided basic restaurant menu information of the first user terminal,
the information provider weighted value is set to increase with an increase in the number of results verified to be inaccurate among the previously provided basic restaurant menu information of the first user terminal,
when the total amount of feedback is the critical amount of feedback or more and positive feedback scores account for the critical proportion or more relative to negative feedback scores, the basic restaurant menu information is verified as accurate,
when the total amount of feedback is the critical amount of feedback or more and the positive feedback scores account for less than the critical proportion relative to the negative feedback scores, the basic restaurant menu information is verified as inaccurate, and
the positive feedback scores or the negative feedback scores are each based on a product of a feedback provider weighted value set for each of the plurality of second user terminals and a set reference feedback score.
